(19) United States
(12) Patent Application Publication
(10) Pub. No.: US 2017/0176173 A1
(43) Pub. Date: Jun. 22, 2017

(54) MEASURING SURFACE LAYER THICKNESS

(71) Applicant: Intel Corporation, Santa Clara, CA (US)

(72) Inventors: Yanmei Song, Chandler, AZ (US); Yongmei Liu, Gilbert, AZ (US); Deepak Goyal, Phoenix, AZ (US); Donglai David Lu, Chandler, AZ (US); Marcel A. Wall, Chandler, AZ (US)

(21) Appl. No.: 14/973,131

(22) Filed: Dec. 17, 2015

(51) Int. Cl. G01B 11/06

(52) U.S. Cl. CPC G01B 11/06

(57) ABSTRACT

Described herein are devices and techniques for measuring a thickness of a surface layer. A device can include a detector, a processor, and a memory. The detector can be arranged to receive reflected light from a surface of a sample. The processor can be in electrical communication with the detector. The memory can store instructions that, when executed by the processor, can cause the processor to perform operations. The operations can include receiving optical data from the detector, determining a polarization change of the reflected light, the polarization change being a function of the optical data, and determining a thickness of the surface layer using the polarization change and the wavelength of the incident light. The optical data can include information regarding the phase difference of the reflected light and the incident light. Also described are other embodiments.

### TECHNICAL FIELD

Embodiments described generally herein relate to measuring a thickness of a surface layer. Some embodiments relate to oxide layer thickness inline monitoring using spectroscopic ellipsometry.

### BACKGROUND

Currently, there are no known non-destructive systems and methods available for thickness non-uniformity monitoring for metal oxides, such as copper oxides, nickel oxide, and tin oxide and organic solderability preservative (OSP). The destructive electrochemical method of sequential electrochemical reduction analysis (SERA) can be used to measure the copper oxide thickness absolute values but only for thin oxide layer of within several nanometer thickness. For copper OSP thickness measurements, ultraviolent (UV) absorption can be used by measuring a dissolved OSP film in acid solution. However, both methods are destructive with long throughput times that also require coupon preparation.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a schematic for measuring the thickness of a surface layer in accordance with some embodiments.

FIG. 2 illustrates a model sample in accordance with some embodiments.

FIGS. 3A and 3B illustrate measurement results for copper oxide layers in accordance with some embodiments.

FIG. 4 illustrates copper oxide thickness values measured using SERA for comparison to copper oxide thickness values obtained in accordance with some embodiments.

FIGS. 5A and 5B illustrate copper oxide thickness measurements in accordance with some embodiments.

FIG. 6 illustrates a model for determining non-uniformity in accordance with some embodiments.

FIGS. 7A and 7B illustrate data for non-uniformity measurements for copper OSP samples in accordance with some embodiments.

FIG. 8 illustrates an example schematic of a computing device in accordance with some embodiments.

FIG. 9 illustrates an example method for measuring surface layer thickness and non-uniformity in accordance with some embodiments.

### DETAILED DESCRIPTION

Inline monitoring of the thickness and non-uniformity of metal oxides such as copper oxide, nickel oxide, and tin oxide and OSP layers is critical in preventing downstream yield, quality, and reliability issues such as missing pad, non-wet, and copper/build up material delamination during substrate packaging technology development (SPTD). For example, one process issue that SPTD can face is copper to build up materials delamination and build up materials cracking potentially due to non-uniform distribution of copper oxide layer post surface treatment and before the lamination process. Accurately measuring the metal oxide thickness is important in understanding the root cause of this issue as well as developing baseline processes. Currently, there is no feasible non-destructive method available to measure a metal oxide layer thickness. As used herein copper oxide can include reference to any oxidation state of copper including CuO and Cu₂O. Non-limiting examples of OSP layer materials include benzotriazoles, imidazoles, and benzimidazoles.

Destructive methods, such as time-of-flight secondary ion mass spectrometry (TOFSIMS) and SERA, can be used only for failure analysis purposes and can have many limitations and long throughput time. The innovative metrology proposed herein utilizes polarization optics to provide a non-destructive noncontact method for in-line monitoring, or a stand-alone metrology, for measuring a copper oxide or OSP thickness or non-uniformity.

The systems and methods disclosed herein can utilize polarization optics at a certain spectral range to measure the thickness and non-uniformity of copper oxide and OSP layers by use of a sample surface's complex refractive index. For example, when a polarized light is reflected from a thin film sample surface, a change of polarization can be dependent on a unique property of the sample's top layer refractive index and layer thickness. As disclosed herein an optical dispersion model can be developed for different types of samples, such as a copper sample. Fitting the refractive index under certain spectral wavelength ranges to the developed dispersion models can provide fast and high precision thickness measurement of a top or surface layer thickness.

The systems and methods disclosed herein provide a novel metrology to measure the thickness non-uniformity of copper oxide and OSP layers. The systems and methods disclosed herein can be used to measure thickness non-uniformity of copper oxide and OSP layers on top of bulk copper during substrate packaging development process. This metrology can offer many advantages over current methods. For example, the systems and methods disclosed herein are non-destructive and non-contact. Thus, samples are not destroyed or otherwise contaminated during a measurement process. In addition, faster throughput times can be achieved. For instance, in various embodiments, measurements can be made in less than one second for one measurement point. The systems and methods disclosed herein can also be used as a stand-alone metrology that can allow operators to make routine measurements to solve process issues. The systems and methods disclosed herein can also allow large areas, or panel mapping, in order to provide in-situ process monitoring of the thickness and non-uniformity of oxide layers. Furthermore, the systems and methods disclosed herein can allow for high precision measurements. The accuracy of the measurements can be below 1 nm and in the range of 0.1 nm to 10 μm. Moreover, the systems and methods disclosed herein can be used to monitor the thickness of both copper oxides and copper OSP on highly roughened copper substrates.

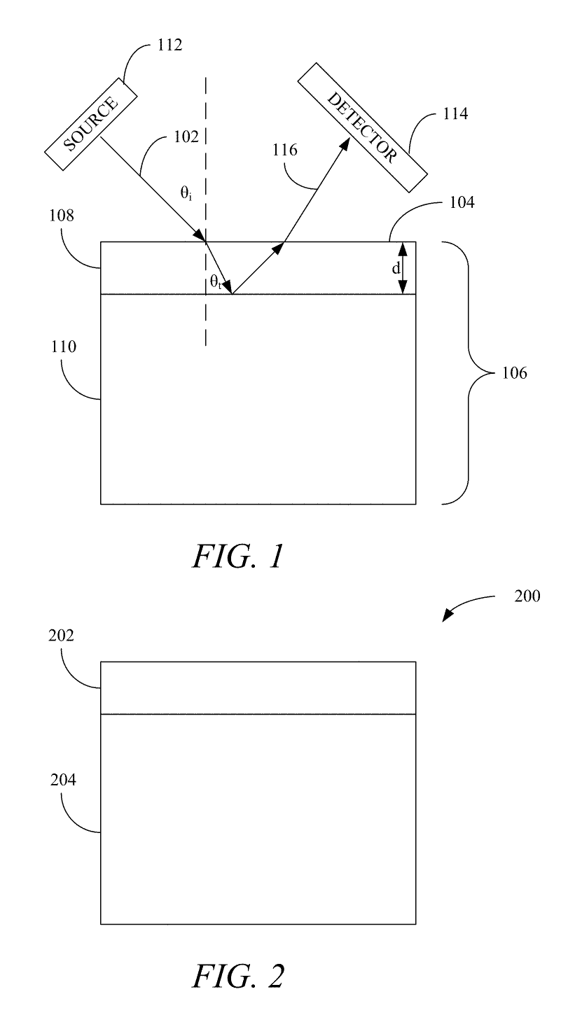

FIG. 1 illustrates a schematic for measuring the thickness of a surface layer. As shown in FIG. 1, a polarized light 102 can interact with a surface 104 of a sample 106. The interaction can cause a change in the polarization of the polarized light 102. The change in polarization can depend on the refractive index and thickness of a surface layer 108 (e.g., a copper oxide or copper OSP layer). The refractive index can vary with properties of the surface layer 108 as well as with different light wavelengths. For example, under certain spectral ranges, when the polarized light 102 travels though the surface layer 108, a portion of the polarized light 102 can be reflected to the surface 104 from an interface between the surface layer 108 and a bulk material 110 (e.g., copper).

Consistent with embodiments disclosed herein the bulk material 110 can absorb a portion of the polarized light 102 that transmits through the surface layer 108. A polarization change, ψ, (sometimes referred to as an amplitude component) of the light reflected from the interface of the surface layer 108 and the bulk material 110 can be a function of properties of the materials. For example, the polarization change can be a function of optical constants, such as complex refractive index, n̅=n−iκ, where n is the refractive index and κ is the extension coefficient. In addition, the polarization change can be a function of other properties such a thickness, d, of surface layer 108. By measuring the light polarization change as a function of different wavelengths, the thickness and thickness non-uniformity of the surface layer 108 (e.g., a copper oxide or copper OSP layer) can be determined. For instance, as disclosed herein the thickness and thickness non-uniformity can be determined using a regression analysis of newly established optical dispersion models.

As shown in FIG. 1, a source 112, can direct the polarized light 102 at surface 104 at an angle, θᵢ, and a detector 114 can collect reflected light 116. The source 112 can direct light in wavelength ranges from about 200 nm to about 2,100 nm. This wavelength range includes the visible spectrum of about 400 nm to about 800 nm. In addition, the source 112 can utilize various lenses or filters to produce a desire polarization. The detector 114, or other computing device in electrical communication with the detector 114, can determine a wavelength, λ, and phase difference, Δ, of the reflected light 116. Using the measured quantities, the polarization change, ψ, can be determined using Eq. I.

$$n - ik = {n}_{i} sin {θ}_{i} \sqrt{1 + {tan}^{2} {{θ}_{i} ( \frac{1 - tan Ψ {e}^{i Δ}}{1 + tan Ψ {e}^{i Δ}} )}^{2}} \qquad Eq . I$$

Once the polarization change has been determined, the thickness of the surface layer 108 can be determined using Eq. II and other know quantities such as angle of incidence, θᵢ, wavelength, λ, and refractive index, n.

$$Polarization change = Ψ = 2 π ( \frac{d}{λ} ) {n}_{i} cos {θ}_{i} \qquad Eq . II$$

Using the above equations in conjunction with the systems and methods disclosed herein, accurate measurement of copper oxide thickness on different type of copper samples have been obtained.

While FIG. 1 illustrates a copper sample, FIG. 2 illustrates a generic sample 200 for use with the systems and methods disclosed herein. As shown in FIG. 2, the sample 200 includes a top layer 202 and a bulk layer 204. In the embodiments disclosed herein, the top layer 202 can be an oxide, such as a copper oxide, that can be represented by assuming 50% underlying bulk layer (e.g., copper) and 50% void. The bulk layer 204 can be assumed to be 100%, or nearly 100%, pure. For example, the bulk layer 204 can be materials such as copper, nickel, tin, and aluminum. The top layer 202 can be any oxide of the bulk layer 204.

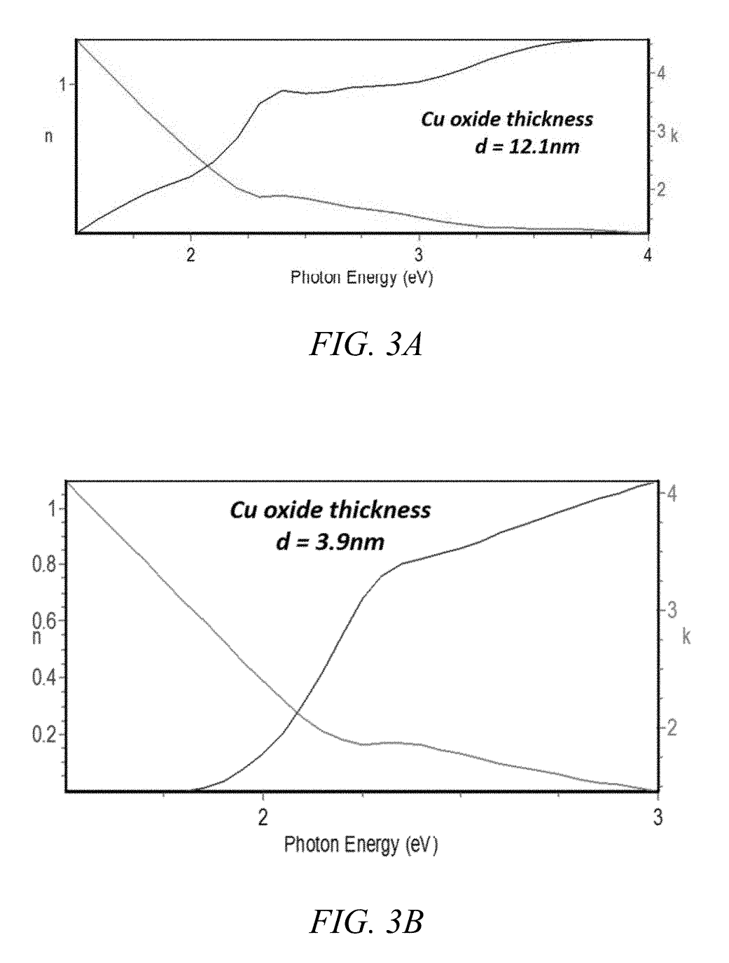

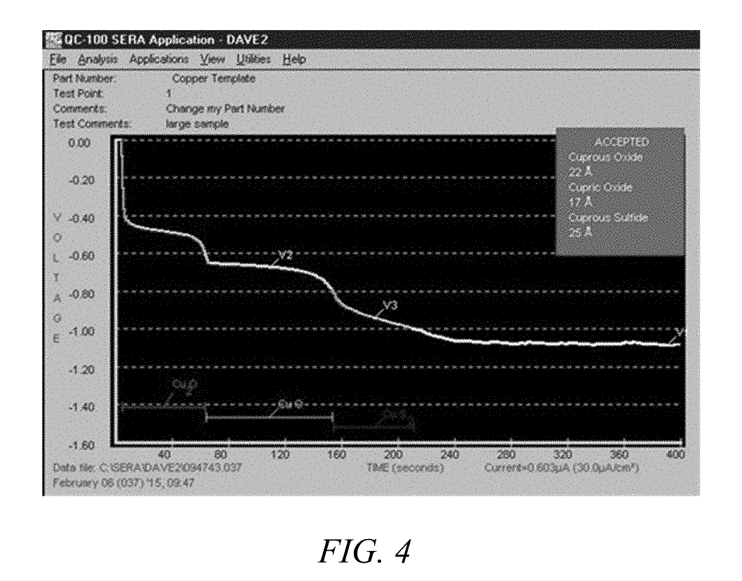

FIGS. 3A and 3B illustrate measurement results on SPTD copper samples post an electroplating process. FIG. 3A shows a sample having a copper oxide layer with measured thickness of 12.1 nm. FIG. 3B shows a sample having a copper oxide layer with a measured thickness of 3.9 nm. For validation purpose, a copper oxide layer on an electrolytic copper sample (the same sample as in FIG. 3B) was measured using the systems and methods disclosed herein and SERA. As shown in FIG. 4, the copper oxide thickness value measured using SERA was 3.9 nm (2.2 nm+1.7 nm), which is consistent with measurements taken using the systems and methods disclosed herein.

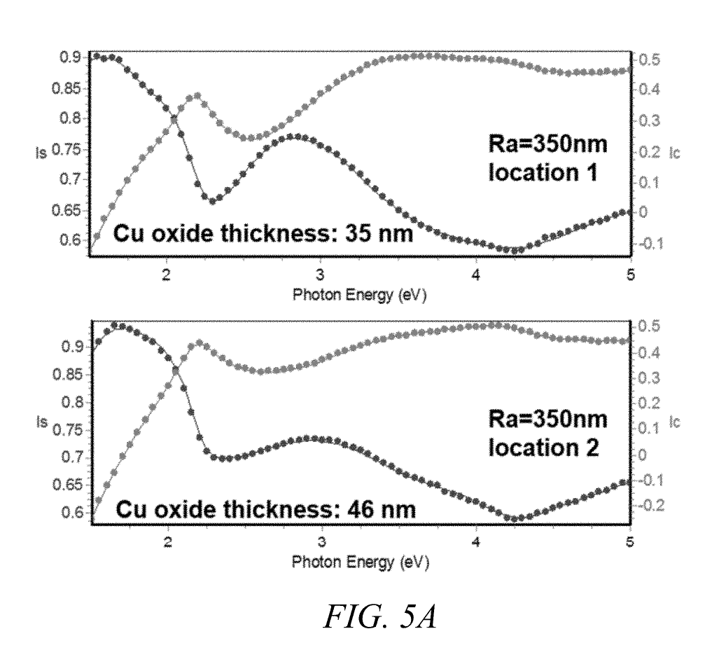

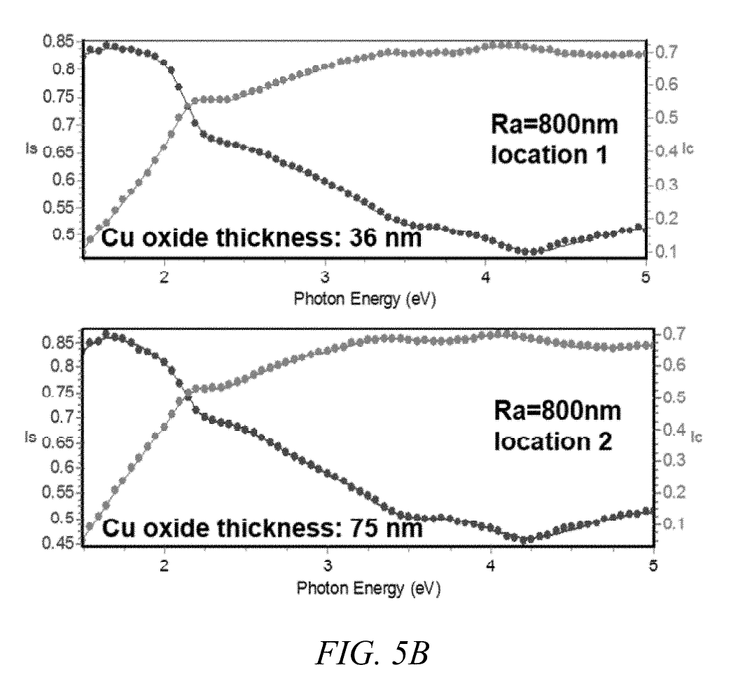

Consistent with embodiments disclosed herein, the metrology disclosed herein can also be used to successfully measure the copper oxide thickness on rough copper samples after a chemical roughing process. FIGS. 5A and 5B illustrate copper oxide thickness measurement results using the disclosed metrology for copper samples post roughing. As shown in FIGS. 5A and 5B, the copper oxide thickness with roughness measures 350 nm and 800 nm, respectively. Locations 1 and 2 are two different locations selected on the same sample. As shown in FIGS. 5A and 5B, the copper oxide thickness and thickness variation across different sample locations and different copper roughness can clearly be detected using the metrology disclosed herein.

Due to the high cost of nickel/palladium/gold surface finishes, copper OSP finishes can be used for low lost packaging assembly and substrate technology development. Due to the nature of the non-uniformity of copper OSP film, the absolute thickness value can change significantly by varying spot (i.e., sample) size and location. Conventional UV absorption methods has to go through at least three steps: 1) coupon preparation (e.g., a 10×2.5 mm sample sizes), 2) acid dissolving, and 3) absorptiometry by UV spectrometry to determine the non-uniformity and thickness of the copper OSP layer. UV spectrometry is destructive, requires long throughput time, and cannot be used to measure small area. Copper OSP thickness and non-uniformity measurements have been successfully obtained using the systems and methods disclosed herein.

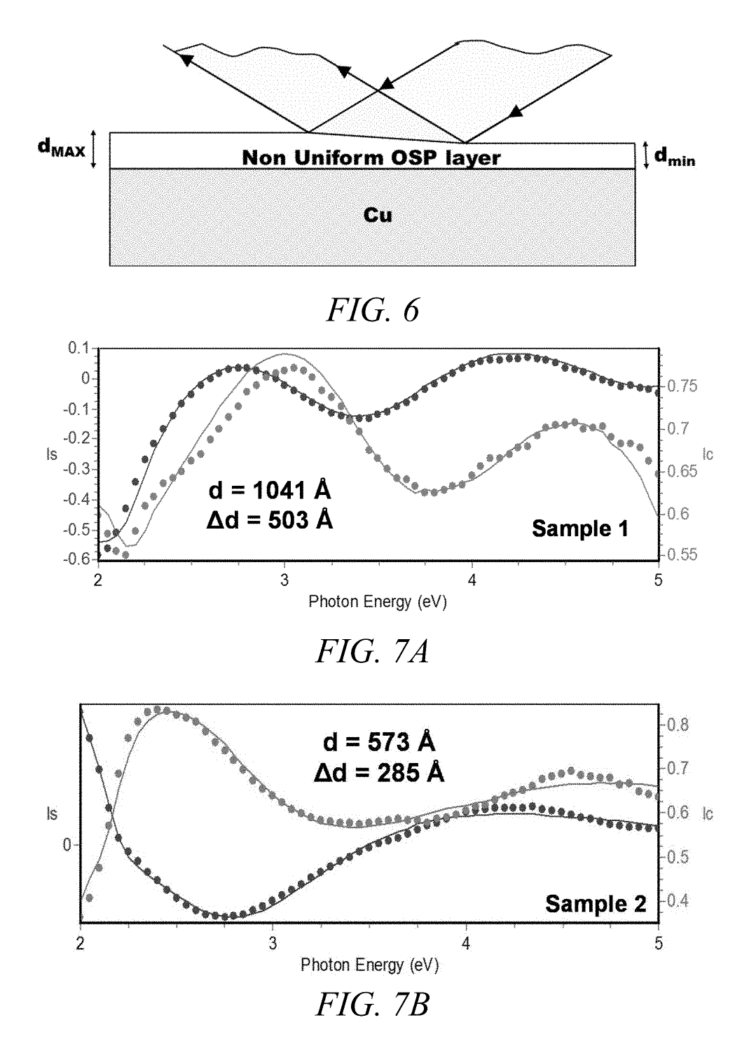

FIG. 6 illustrates a schematic for determining copper OSP non-uniformity consistent with embodiments disclosed herein. The method can assume a copper OSP normal thickness, d, and thickness non-uniformity, Λd. Just as with FIG. 1, light sources and detectors can be used to direct incident light and collect reflected light. FIGS. 7A and 7B show data for non-uniformity measurements for copper OSP samples. Using the collected data the nominal thickness, d, for the copper OSP layer can be calculated using Eq. III.

$$d = \frac{{d}_{min} + {d}_{max}}{2} \qquad Eq . III$$

The thickness non-uniformity can be calculated using Eq. IV.

Δd=dₘₐₓ−dₘᵢₙ Eq. IV

Using the data from FIGS. 7A and 7B the nominal thickness for the two samples can be calculated to be 1041 and 573 Angstroms, respectively. The thickness non-uniformity for the two samples can be calculated to be 503 and 285 Angstroms, respectively. As shown in FIGS. 7A and 7B, the non-uniformity of the copper OSP layer can be about half of the thickness of the copper OSP layer.

The above examples show use of the metrology disclosed herein for using measuring copper oxide and copper OSP thickness and thickness non-uniformity in one context. However, this one context should not be construed as limiting the disclosure. The metrology disclosed herein can be applied in other applications and examples. For example, the metrology disclosed herein can be applied to measure oxide layers for different oxides, such as nickel oxide, aluminum oxide, tin oxide, etc.

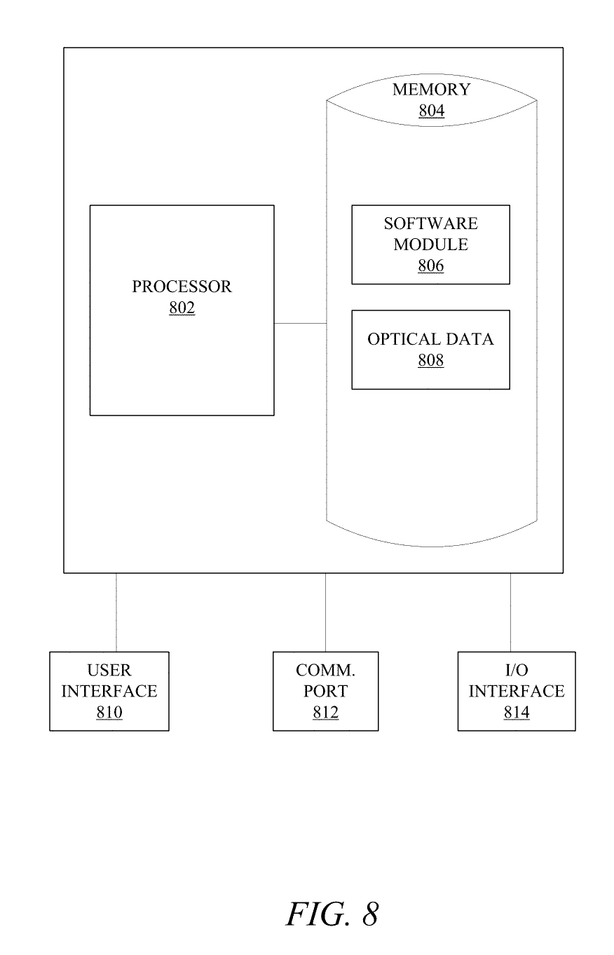

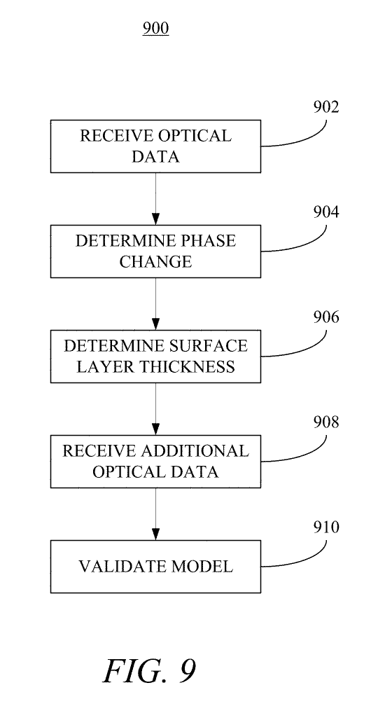

FIG. 8 illustrates an example schematic of a computing device 800. As shown in 800, computing device 800 may include a processor 802 and a memory unit 804. The memory unit 804 may include a software module 806 and optical data 808. While executing on the processor 802, the software module 806 may perform processes for determining thickness and thickness non-uniformity, including, for example, one or more stages included in method 900 described below with respect to FIG. 9.

Optical data 808 may include the wavelength, frequency, incident angle, polarization change, refractive index, extinction coefficient, etc. as described herein. The computing device 800 may also include a user interface 810. The user interface 810 can include any number of devices that allow a user to interface with the computing device 800. Non-limiting examples of the user interface 810 can include a keypad, a microphone, a speaker, a display (touchscreen or otherwise), etc.

The computing device 800 may also include a communications port 812. The communications port 812 can allow the computing device 800 to communicate with other computing devices and testing instrumentation such as spectrometers. Non-limiting examples of the communications port 812 can include, Ethernet cards (wireless or wired), serial ports, parallel ports, etc.

The computing device 800 can also include an input/output (I/O) device 814. The I/O device 814 can allow the computing device 800 to receive and output information. Non-limiting examples of the I/O device 814 can include, a camera (still or video), a printer, a scanner, etc.

The computing device 800 can be implemented using a personal computer, a network computer, a mainframe, a handheld device, a personal digital assistant, a smartphone, or any other similar microcomputer-based workstation. The computing device 800 can be a standalone device or can be combined with another device. For example, the computing device 800 may be a desktop computer used by a user that is connect to a spectrometer. In addition, the computing device 800 can be integrated into a spectrometer. In this instance, the computing device 800 can also include software, stored in the software module 806, that can control the source and detectors used to collect data as described herein.

FIG. 9 illustrates an example method 900 for determining layer thickness and thickness non-uniformity. The method 900 may begin at stage 902 where optical data can be received, for example, by the computing device 800. The optical data can include incident angle, θ, wavelength, λ, of incident and reflected light, refractive index, etc. as described herein. In addition, the optical data can include data for a single location, or spot, on the sample or can be for multiple locations, or spots, on the sample. For instance, the systems and methods disclosed herein allow for collection of data for spots as small as about 25 microns. Thus, data can be collected over a variety of sample spots. The various data can be used to map a contour of the surface layer.

From stage 902, the method 900 can proceed to stage 904 where a polarization change of the reflected light can be determined, for example by the computing device 800. The polarization change being a function of the optical data as described herein.

From stage 904, the method 900 can proceed to stage 906 where a thickness of the surface layer can be determined using, for example by the computing device 800, the polarization change and the wavelength of the incident light. Determining the thickness of the surface layer can include formulating a model to utilize in determining the thickness of the surface layer. For instance, for different surface layers, different models can be utilized to determine the surface layer thickness due to the different optical properties of the different surface layers.

From stage 906, the method 900 can be proceed to stage 908 where additional data can be received. For example, additional data, such as additional optical data, can be received that was collected by a different method or system that the original optical data. For instance, the additional data can be collected using UV spectroscopy.

From stage 908, the method 900 can proceed to stage 910 where the additional data can be utilized to confirm the determination of the thickness of the surface layer. For example, a model created to determine the thickness of a surface layer may need to be validated to determine if the model accurately determines the thickness of the surface layer. Thus, the additional data can be collected by a second technique and used to calculate the thickness of surface layer for comparison to results given by the model.

The term “module” is understood to encompass a tangible entity, be that an entity that is physically constructed, specifically configured (e.g., hardwired), or temporarily (e.g., transitorily) configured (e.g., programmed) to operate in a specified manner or to perform at least part of any operation described herein. Considering examples in which modules are temporarily configured, a module need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. The term “application,” or variants thereof, is used expansively herein to include routines, program modules, programs, components, and the like, and may be implemented on various system configurations, including single-processor or multiprocessor systems, microprocessor-based electronics, single-core or multi-core systems, combinations thereof, and the like. Thus, the term application may be used to refer to an embodiment of software or to hardware arranged to perform at least part of any operation described herein.

While a machine-readable medium may include a single medium, the term “machine-readable medium” may include a single medium or multiple media (e.g., a centralized or distributed database, and/or associated caches and servers).

The term “machine-readable medium” may include any medium that is capable of storing, encoding, or carrying instructions for execution by a machine (e.g., the computing device 800 or any other module) and that cause the machine to perform any one or more of the techniques of the present disclosure, or that is capable of storing, encoding or carrying data structures used by or associated with such instructions. In other words, the processor 802 can include instructions and can therefore be termed a machine-readable medium in the context of various embodiments. Other non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions may further be transmitted or received over a communications network using a transmission medium utilizing any one of a number of transfer protocols (e.g., frame relay, internet protocol (IP), TCP, user datagram protocol (UDP), hypertext transfer protocol (HTTP), etc.). Example communication networks may include a local area network (LAN), a wide area network (WAN), a packet data network (e.g., the Internet), mobile telephone networks ((e.g., channel access methods including Code Division Multiple Access (CDMA), Time-division multiple access (TDMA), Frequency-division multiple access (FDMA), and Orthogonal Frequency Division Multiple Access (OFDMA) and cellular networks such as Global System for Mobile Communications (GSM), Universal Mobile Telecommunications System (UMTS), CDMA 2000 1x* standards and Long Term Evolution (LTE)), Plain Old Telephone (POTS) networks, and wireless data networks (e.g., Institute of Electrical and Electronics Engineers (IEEE) 802 family of standards including IEEE 802.11 standards (WiFi), IEEE 802.16 standards (WiMax®) and others), peer-to-peer (P2P) networks, or other protocols now known or later developed.

The term “transmission medium” shall be taken to include any intangible medium that is capable of storing, encoding or carrying instructions for execution by hardware processing circuitry, and includes digital or analog communications signals or other intangible medium to facilitate communication of such software.

### ADDITIONAL NOTES & EXAMPLES:

Example 1 includes a system for determining a thickness of a surface layer. The system can include a detector, a processor, and a memory. The detector can be arranged to receive reflected light from a surface of a sample. The reflected light can have a phase difference from incident light. The phase difference can be due to the incident light passing through the surface layer. The processor can be in electrical communication with the detector. The memory can store instructions that, when executed by the processor, can cause the processor to perform operations. The operations can include receiving optical data from the detector, determining a polarization change of the reflected light, and determining a thickness of the surface layer using the polarization change and the wavelength of the incident light. The optical data can include information regarding the phase difference of the reflected light and the incident light. The polarization change being a function of the optical data.

In Example 2, Example 1 can optionally include a light source arranged to direct the incident light onto the surface of the sample.

In Example 3, any one of the preceding Examples can optionally include the incident light being polarized.

In Example 4, any one of the preceding Examples can optionally include the wavelength being between about 200 nm and about 2,100 nm.

In Example 5, Example 4 can optionally include the wavelength being between about 400 nm to about 800 nm.

In Example 6, any one of the preceding Examples can optionally include the incident light having a spot size of about 25 microns.

In Example 7, any one of the preceding Examples can optionally include the optical data including optical data for multiple locations on the surface of the sample.

In Example 8, any one of the preceding Examples can optionally include the surface layer including CuO or Cu₂O.

In Example 9, any one of the preceding Examples can optionally include the surface layer including a copper organic solderability preservative.

In Example, 10, any one of the preceding Examples can optionally operations further comprising: receiving additional optical data; and utilizing the additional optical data to confirm the determination of the thickness of the surface layer.

Example 11 can include a method for determining the thickness of a surface layer of a sample. The method can include: receiving, at a computing device including a processor, optical data from a detector; determining, by the computing device, a polarization change of reflected light; and determining, by the computing device, a thickness of the surface layer using the polarization change and the wavelength of the incident light. The optical data can include information regarding a phase difference between the reflected light and incident light. The polarization change can be a function of the optical data.

In Example 12, Example 11 can optionally include formulating a model to utilize in determining the thickness of the surface layer.

In Example 13, any one of Examples 11 or 12 can optionally include the incident light being polarized.

In Example 14, any one of Examples 11-13 can optionally include the wavelength being between about 200 nm and about 2,100 nm.

In Example 15, any one of Examples 11-14 can optionally include the incident light having a spot size of about 25 microns.

In Example 16, any one of Examples 11-15 can optionally include receiving optical data for multiple locations on the surface of the surface layer.

In Example 17, any one of Examples 11-16 can optionally include the surface layer including CuO, Cu₂O, or a copper organic solderability preservative.

In Example 18, any one of Examples 11-17 can option include: receiving additional optical data; and utilizing the additional optical data to confirm the determination of the thickness of the surface layer.

Example 19 can include a system for determining a thickness of a surface layer. The system can include: means for directing incident light onto a surface of a sample; means for detecting reflected light reflected from the surface of the sample; means for receiving optical data from the detecting means; means for determining a polarization change of the reflected light, the polarization change being a function of the optical data; and means for determining a thickness of the surface layer using the polarization change and the wavelength of the incident light. The reflected light can have a phase difference that differs from the incident light due to the incident light passing through the surface layer. The optical data can include information regarding the phase difference of the reflected light and the incident light.

In Example 20, Example 19 can optionally include the incident light being polarized.

In Example 21, any one of Examples 19 or 20 can optionally include the wavelength being between about 200 nm and about 2,100 nm.

In Example 22, any one of Examples 19-21 can optionally include the incident light having a spot size of about 25 microns.

In Example 23, any one of Examples 19-22 can optionally include the means for directing the incident light including means for directing the incident light to multiple locations on the surface of the sample and the means for detecting the reflected light including means for detecting the reflected light from the multiple locations.

In Example 24, any one of Examples 19-23 can optionally include the surface layer including at least one of CuO, Cu₂O, or a copper organic solderability preservative.

Example 25 can include a machine-readable medium that can include instructions that, when executed by a processor, cause the processor to perform operations. The operations can comprise: receiving optical data from a detector; determining a polarization change of reflected light; and determining a thickness of the surface layer using the polarization change and a wavelength of the incident light. The optical data can include information regarding a phase difference of the reflected light and incident light. The polarization change can be a function of the optical data.

In Example 26, Example 25 can optionally include the instructions further comprising formulating a model to utilize in determining the thickness of the surface layer.

In Example 27, any one of Examples 25 or 26 can optionally include receiving optical data for multiple locations on the surface of the surface layer.

In Example 28, any one of Examples 25-27 the instructions can optionally include: receiving additional optical data; and utilizing the additional optical data to confirm the determination of the thickness of the surface layer.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. However, the claims may not set forth features disclosed herein because embodiments may include a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

Claimed is:

1. A system for determining a thickness of a surface layer, the system comprising:
a detector arranged to receive reflected light from a surface of a sample, the reflected light having a phase difference from incident light due to the incident light passing through the surface layer;
a processor in electrical communication with the detector; and
a memory that stores instructions that, when executed by the processor, cause the processor to perform operations comprising:
receiving optical data from the detector, the optical data including information regarding the phase difference of the reflected light and the incident light,
determining a polarization change of the reflected light, the polarization change being a function of the optical data, and
determining the thickness of the surface layer using the polarization change and a wavelength of the incident light.

2. The system of claim 1, further comprising a light source arranged to direct the incident light onto the surface of the sample.

3. The system of claim 1, wherein the incident light is polarized.

4. The system of claim 1, wherein the wavelength is between about 200 nm and about 2,100 nm.

5. The system of claim 4, wherein the wavelength is between about 400 nm to about 800 nm.

6. The system of claim 1, wherein the incident light has a spot size of about 25 microns.

7. The system of claim 1, wherein the optical data includes optical data for multiple locations on the surface of the sample.

8. The system of claim 1, wherein the surface layer includes at least one of CuO or Cu₂O.

9. The system of claim 1, wherein the surface layer includes a copper organic solderability preservative.

10. The system of claim 1, wherein the operations further comprise:
receiving additional optical data; and
utilizing the additional optical data to confirm the thickness of the surface layer.

11. A method for determining a thickness of a surface layer of a sample, the method comprising:
receiving optical data from a detector, the optical data including information regarding a phase difference between reflected light and incident light;
determining a polarization change of the reflected light, the polarization change being a function of the optical data; and
determining the thickness of the surface layer using the polarization change and a wavelength of the incident light.

12. The method of claim 11, further comprising formulating a model to utilize in determining the thickness of the surface layer.

13. The method of claim 11, wherein the incident light is polarized.

14. The method of claim 11, wherein the wavelength is between about 200 nm and about 2,100 nm.

15. The method of claim 11, wherein the incident light has a spot size of about 25 microns.

16. The method of claim 11, wherein receiving the optical data includes receiving optical data for multiple locations on a surface of the surface layer.

17. The method of claim 11, wherein the surface layer includes CuO, Cu₂O, or a copper organic solderability preservative.

18. The method of claim 11, further comprising:
receiving additional optical data; and
utilizing the additional optical data to confirm the thickness of the surface layer.

19. A system for determining a thickness of a surface layer, the system comprising:
means for directing incident light onto a surface of a sample;
means for detecting reflected light reflected from the surface of the sample, the reflected light having a phase difference from the incident light due to the incident light passing through the surface layer;
means for receiving optical data from the detecting means, the optical data including information regarding the phase difference of the reflected light and the incident light;
means for determining a polarization change of the reflected light, the polarization change being a function of the optical data; and
means for determining the thickness of the surface layer using the polarization change and a wavelength of the incident light.

20. The system of claim 19, wherein the incident light is polarized.

21. The system of claim 19, wherein the wavelength is between about 200 nm and about 2,100 nm.

22. The system of claim 19, wherein the incident light has a spot size of about 25 microns.

23. The system of claim 19, wherein the means for directing the incident light includes means for directing the incident light to multiple locations on the surface of the sample and wherein the means for detecting the reflected light includes means for detecting the reflected light from the multiple locations.

24. The system of claim 19, wherein the surface layer includes CuO, Cu₂O, or a copper organic solderability preservative.

25. A machine-readable medium including instructions that, when executed by a processor, cause the processor to perform operations comprising:
receiving optical data from a detector, the optical data including information regarding a phase difference between reflected light and incident light;
determining a polarization change of the reflected light, the polarization change being a function of the optical data; and
determining a thickness of a surface layer using the polarization change and a wavelength of the incident light.

26. The machine-readable medium of claim 25, wherein the instructions further comprises formulating a model to utilize in determining the thickness of the surface layer.

27. The machine-readable medium of claim 25, wherein receiving the optical data includes receiving optical data for multiple locations on a surface of the surface layer.

28. The machine-readable medium of claim 25, wherein the operations further comprise:
receiving additional optical data; and
utilizing the additional optical data to confirm the thickness of the surface layer.
